(19) United States
(12) Patent Application Publication
(10) Pub. No.: US 2012/0183308 A1
(43) Pub. Date: Jul. 19, 2012

(54) IMAGE FORMING APPARATUS AND IMAGE FORMING METHOD

(76) Inventor: Yuichi OMORI, Tokyo (JP)

(21) Appl. No.: 13/348,983

(22) Filed: Jan. 12, 2012

(30) Foreign Application Priority Data
Jan. 17, 2011 (JP) JP2011-006533
Oct. 21, 2011 (JP) JP2011-231620

(51) Int. Cl. G03G 15/00

(52) U.S. Cl. 399/16; 399/395

(57) ABSTRACT

An image forming apparatus includes: a registration roller which corrects a skew of the envelope and conveys the envelope to the transferring section; a sensor provided between a transferring section and the registration roller wherein in a case when an envelope is conveyed with a side of the main body thereof having the flap portion being parallel to the conveying direction and the flap portion being located where the end detected is by the sensor, a controller allows the sensor to detect a position of the end of the parallel portion of the flap portion when the registration roller and the sensor are located at the parallel portion of the flap portion, and the controller changes a latent image writing position by the writing section in an image scanning direction perpendicular to the conveyance direction of the envelope according to the detection result by the sensor

This application is based on Japanese Patent Application Nos. 2011-006533 filed on Jan. 17, 2011 and 2011-231620 filed on Oct. 21, 2011, which is incorporated hereinto by reference.

### BACKGROUND OF THE INVENTION

The present invention relates to an image forming apparatus for forming an image on an envelope and a method for forming this image.

Some of the conventional image forming apparatuses such as photocopiers, printers and facsimiles have a function of forming an image on an envelope.

Differently from plain paper, an envelope has a flap portion on the and thereof to be used for pasting. Thus, in a proposal of a method for forming an image on the envelope, consideration is given to the flap portion (e.g., Japanese Patent Application Publication No. 2009-58738).

In the proposal disclosed in the Japanese Patent Application Publication No. 2009-58738, when the envelope is fed with the flap portion located downstream in the sheet conveying direction, the image forming control conditions are changed in response to the open or dose state of the flap portion. To put it more specifically, when the flap portion is conveyed downstream in the sheet conveying direction, there is a change in the conditions for conveying sheets to the transferring section, conditions for writing a latent image on a photoconductor or conditions for the envelope skew correction conditions in a registration roller, in response to the open or close state of the flap portion.

Thus, an image can be formed at a desired position of the envelope, independently of the open or close state of the flap portion of the envelope, by using the image forming method proposed in the Japanese Patent Application Publication No. 2009-58738. In the image forming method proposed in the Japanese Patent Application Publication No. 2009-58738, however, the following problem arises when the envelope is conveyed with the flap portion located downstream in the sheet conveying direction.

In an image forming apparatus wherein envelope skew correction is made by contacting the envelope on the registration roller at rest, the end of the flap portion will be contacted on the registration roller when the envelope is conveyed with the flap portion located downstream in the sheet conveying direction. In this case, the edge of the flap portion contacted on the registration roller is short and the flap portion to be contacted is thinner than the main body of the envelope. This may result in deformation of the flap portion. For example, the flap portion may be crushed. If this occurs, envelope skew correction will end in a failure, with the result that an image cannot be formed at a desired position.

### SUMMARY OF THE INVENTION

In view of the problems described above, it is an object of the present invention to provide an image forming apparatus and image forming method capable of minimizing the envelope skew correction failure and forming an image at a desired position of an envelope on a stable basis.

The object of the present invention can be achieved by any one of the following structures.

1. To achieve at least one of the abovementioned object, an image forming apparatus reflecting one aspect of the present invention, ha& a photoreceptor, a writing section for writing a latent image on the photoreceptor; a developing section for forming a toner image by developing the aforementioned latent image; a transferring section for transferring the toner image on an envelope having a flap portion composed of a parallel portion and an inclined portion, and a main body of the envelope; a registration roller for correcting a skew of the aforementioned envelope and conveying the envelope to the transferring section; a sensor located between the transferring section and the registration roller to detect the position of an end of the parallel portion of the flap that is in parallel with the envelope conveying direction; and a controller for controlling the aforementioned writing section, registration roller and sensor, wherein in a case when the envelope is conveyed with the side of the envelope having the flap portion being parallel to the conveying direction and the flap portion being located where the aforementioned end is detected by the sensor, and the controller allows the sensor to detect the position of the end of the parallel portion of the flap portion, when the registration roller and sensor are located at the parallel portion of the flap portion; and the controller changes the latent image writing position by the writing section according to the result of detection by the sensor.

2. In the image forming apparatus according to the aforementioned Item 1, the aforementioned change of the writing position is preferably the change of the position as a sum total of the shift amount with respect to a reference position and a length from the end of the flap portion to the end of the main body of the envelope

3. In the image fanning apparatus according to the aforementioned Item 1 or 2, the aforementioned change of the writing position is preferably restricted to the change of the shift amount with respect to the reference position to ensure that when the envelope is conveyed, so that the side of the main body of the envelope having the flap portion will be parallel to the conveying direction, and the flap portion will not be located at the end detected by the sensor

4. In the image forming apparatus according to the aforementioned Item 1, the position information on the flap portion of the envelope is preferably set in advance.

5. The image forming apparatus according to the aforementioned Item 4 is preferably provided with an operation and display section for setting the position information of the flap portion.

6. In the image forming apparatus according to the aforementioned Items 1 through 5, the sensor preferably detects a plurality of positions of the flap portion, and the controller preferably calculates the skew amount of the envelope based on the aforementioned result of detecting the plurality of positions.

7. In the image forming apparatus according to the aforementioned Item 6, the controller preferably calculates the skew amount of the envelope based on the aforementioned result of detecting the plurality of positions and the drive period of time of a registration roller at the time of detecting the plurality of positions.

8. The image forming apparatus according to the aforementioned Items 1 through 7 is preferably provided with an envelope detecting sensor for detecting shape information of the envelope and the position of the flap portion in the conveying direction.

9. In the image forming apparatus according to the aforementioned Item 8, the envelope detecting sensor detects the position of the end of the flap along the envelope conveying direction continuously or at prescribed intervals.

10. In the image forming apparatus according to the aforementioned Items 1 through 9, the layout position of the sensor is preferably set in advance

11. One aspect of the image forming method is a method of fanning an image in an image forming apparatus having a photoreceptor, a writing section for writing a latent image on the photoreceptor, a developing section for forming a toner image by developing the aforementioned latent image; a transferring section for transferring the toner image on an envelope having a flap portion composed of a parallel portion and an inclined portion, and a main body of the envelope; a registration roller for connecting the aforementioned envelope skew and conveying the envelope to the transferring section; a sensor located between the transferring section and registration roller to detect the position of one end to be placed in parallel with the aforementioned envelope conveying direction; and a controller for controlling the aforementioned writing section, registration roller and sensor, wherein the aforementioned controller has: a process of conveying the envelope to the registration roller with the side of the envelope having the flap portion being parallel to the conveying direction and the flap portion being located at the aforementioned one end detected by the sensor, a process of correcting the skew of the envelope by the registration roller, a process of allowing the sensor to detect the position of the end of the parallel portion of the flap portion when the registration roller and sensor are located at the parallel portion of the flap portion; and a process of changing the latent image writing position by the writing section according to the result of detection by the sensor.

12. In the image forming method according to the aforementioned Item 11, the aforementioned change of the writing position is preferably the change of the position as a sum total of the shift amount with respect to the reference position and the length from the end of the flap portion to the end of the main body of the envelope.

13. The image forming method according to the aforementioned Item 11 or 12 is preferably provided with a process for conveying the envelope to the registration roller in such a way that the side of the main body of the envelope having the flap portion will be parallel to the conveying direction, and the flap portion will not be located at one end detected by the sensor, wherein the aforementioned change of the writing position is preferably restricted to only the change of the shift amount with respect to the reference position.

### BRIEF DESCRIPTION OF THE DRAWINGS

FIG. 1 is a schematic cross sectional view representing an image forming apparatus in an embodiment of the present invention;

FIG. 2 is a schematic configuration diagram showing the area close to a registration roller and sensor;

FIG. 3 is a block schematic diagram showing the control system of the image forming apparatus;

FIG. 4 is a diagram representing the principle of forming an image on an envelope;

FIG. 5 is a diagram representing an example of setting envelope information;

FIG. 6 is a diagram representing an example of setting envelope information;

FIG. 7 is a flowchart representing the procedure of forming an image on an envelope;

FIG. 8 is a flowchart representing the procedure in Step S4 of FIG. 7;

FIG. 9 is a diagram representing the operation of detecting the skew amount of an envelope in variation 1; and

FIG. 10 is a diagram representing the operation of detecting the envelope information in variation 3.

### DETAILED DESCRIPTION OF THE PREFERRED EMBODIMENT

The following describes an example of the image forming apparatus and image forming method related to the embodiment of the present invention with reference to drawings. <1. Example of Basic Structure>

[Structure of an Image Forming Apparatus]

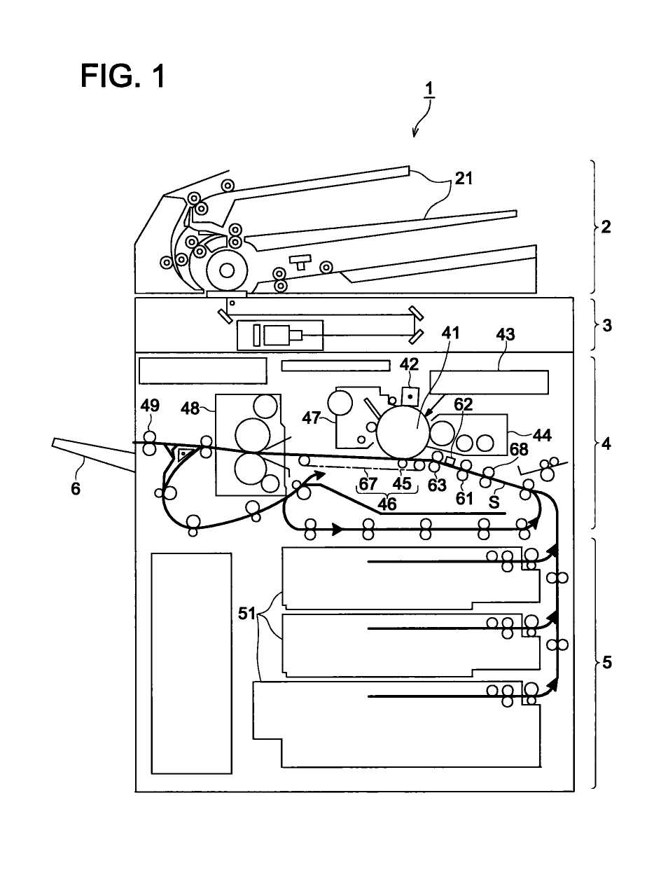

FIG. 1 is a schematic cross sectional view representing an image forming apparatus in an embodiment of the present invention. FIG. 1 shows an example of the structure of the image forming apparatus 1 provided with functions of a photocopier, printer, facsimile and other to form a monochromatic image on a sheet of paper by means of an electrophotographic process.

The image forming apparatus 1 includes a document feed section 2, document reading section 3, image forming section 4, sheet feed section 5 and sheet ejection tray 6. The image forming apparatus 1 incorporates sheet conveyance path S leading from the sheet feed section 5 to the sheet ejection tray 6 through the image forming section 4. This sheet conveyance path S is formed of various rollers, guide plates, conveyance belts and others which are provided in prescribed positions in the image forming apparatus 1.

The image forming apparatus 1 includes a controller 70 for controlling all the operations of the image forming apparatus 1, operation and display section 71 for displaying the operations of the image forming apparatus 1, and image processing section 72 for processing the image data in a prescribed manner (FIG. 3 to be described later).

Further, the image forming apparatus 1 has a registration roller 61 for correcting the sheet skew and a sensor 62 for detecting the shift from the sheet in the reference position, along the sheet conveyance path S leading from the sheet feed section 5 to the image forming section 4.

The document feed section 2 has a plurality of document feed trays 21 and sends the sheets set on a prescribed document feed tray 21 to the document reading section 3.

The document reading section 3 optically reads the document image and converts the information of the document image into an analog electric signal. The document reading section 3 further converts the analog electric signal into a digital signal. The document reading section 3 outputs the converted digital signal as image data to the image processing section.

The image forming section 4 includes a drum-shaped photoreceptor 41, a charging section 42 around the photoreceptor 41, a writing section 43 for writing a latent image on the photoreceptor, a developing section 44 for forming a toner image by developing the aforementioned image on the photoreceptor, and a transfer belt 67 pressed by the transfer roller 45, as well as a transferring section 46 for transferring the toner image on the sheet, a cleaning section 47 for cleaning the surface of the photoreceptor 41; a fixing section 48 for fixing a toner image on the sheet and a sheet ejection roller 49 for ejecting the sheet.

The following describes the specific example of processing by the image forming section 4. The image forming section 4 acquires the image data subjected to prescribed image processing at the image processing section. This is followed by the step of the charging section 42, writing section 43, developing section 44 and transferring section 46 applying the processing of charging writing, development and transferring in that order to the sheet fed from the sheet feed section 5 in conformity to the image data. This procedure allows a toner image formed on the sheet. The fixing section 48 fixes the funned toner image onto the sheet and feeds the fixed sheet to the sheet ejection tray 6 through the sheet ejection roller 49.

The sheet feed section 5 has a plurality of sheet feed cassettes 51 corresponding to various sheets and feeds prescribed sheets on each sheet feed cassette 51 one by one along the sheet conveyance path S to the registration roller 61.

The image forming apparatus 1 of this embodiment can be connected with external terminal equipment such as a personal computer to acquire the image data from the external equipment and to form an image corresponding to the image data on the sheet

[Structure of Registration Conveying Section]

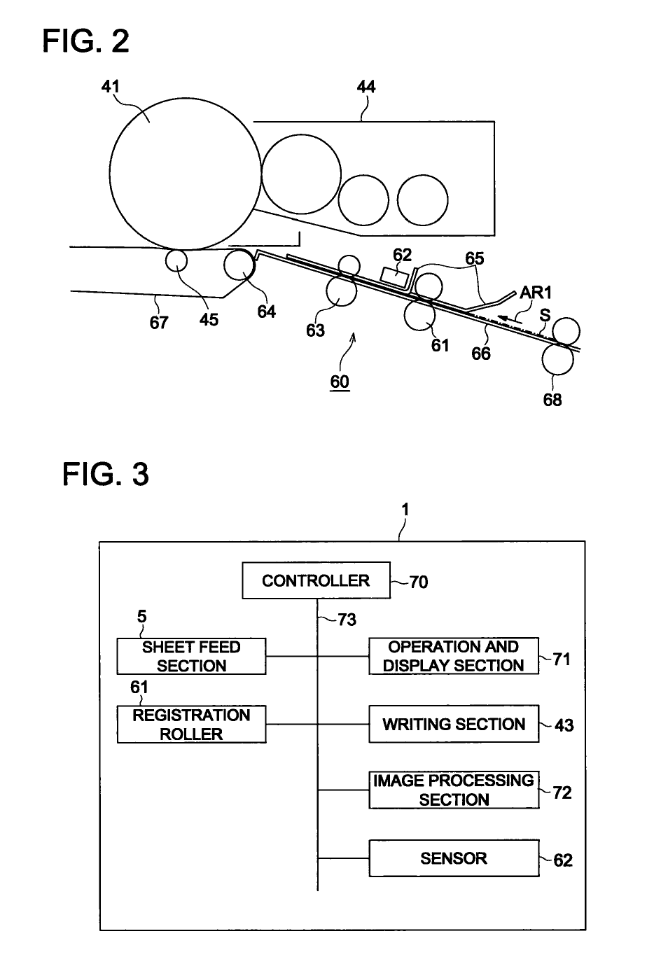

FIG. 2 Illustrates a schematic configuration of the registration conveying section 60 which is installed along the sheet conveyance path S and which is provided with a registration roller 61 for correcting the sheet skew and a sensor 62 for detecting the shift.

The registration conveying section 60 has a registration roller 61, a sensor 62 for detecting the sheet shift and two conveying milers 63 and 64. The registration roller 61, sensor 62 and two conveying rollers 63 and 64 are installed upstream of the transferring section 46 in the sheet conveying direction AR1. Further, the registration roller 61, sensor 62 and two conveying rollers 63 and 64 are arranged in that order, as viewed from the upstream side in the conveying direction AR1.

Further the registration conveying section 60 has an upper guide plate 65 and lower guide plate 66 provided to cover the area wherein the registration roller 61, sensor 62 and conveying roller 63 are installed. Further, the registration conveying section 60 has a transfer belt 67 for feeding the sheet conveyed from the conveying roller 63, through the photoreceptor 41 and transferring section 46. The transfer belt 67 is installed on the conveying roller 64 and is driven by the rotation of the conveying roller 64, so that the sheet is conveyed.

In the image formation mode, the registration roller 61 corrects the skew of the sheet conveyed from the sheet feed section 5. To put it more specifically, the sheet fed from the sheet feed section 5 is made to contact the registration roller 61 at standstill. This is followed by the step of the sheet being fed by the loop forming roller 68 to form a loop. This procedure corrects the screw at the end of the sheet contacting the registration roller 61. After that, the skew-corrected sheet is conveyed by the registration roller 61 to reach the transferring section 46.

The sensor 62 for detecting the shift detects the shift of the sheet at the end in the direction perpendicular to the sheet conveying direction AR1.

The sensor 62 detects the light reflected from the sheet. Based on the detection signal thereof the sensor 62 detests the edge position of the sheet to be conveyed. The sensor 62 outputs the result of detection to the controller. For example, the sensor 62 can be composed of line sensors wherein a plurality of photosensors are arranged in the main scanning direction, for example.

The sheet having passed through the sensor 62 is guided by the upper guide plate 65 and lower guide plate 66, and is further fed to the transferring section 46 by the transfer belt 67 driven by the conveying roller 64.

[Structure of Image Forming Apparatus Control System]

FIG. 3 is a block schematic diagram showing the control system of the image forming apparatus. For brevity, FIG. 3 shows only the components that function in the mode of forming an image on the envelope.

The control system of the image forming apparatus 1 includes a controller 70, sheet feed section 5, operation and display section 71, registration roller 61, writing section 43, image processing section 72 and sensor 62, and is connected electrically through the system bus 73.

The sheet feed section 5, registration roller 61, writing section 43 and sensor 62 of FIG. 3 have the same structures as those illustrated in FIGS. 1 and 2, and will not be described to avoid duplication.

The controller 70 includes a CPU (Central Processing Unit), ROM, RAM and others to control all the operations of the aforementioned components and image forming apparatus 1.

The operation and display section 71 displays the conditions of operations of the image forming apparatus 1, and the results of these operations. Further, in the present embodiment, the operation and display section 71 is designed in such a way as to allow the user to enter the operation information directly into the operation and display section 71. To put it another way, the display section 71 has a function as an operation panel. Without the present invention being restricted thereto, an operation input section for allowing the user to enter operation information can be provided, separately from the operation and display section 71.

The image processing section 72 applies prescribed processing to the image data of the document read by the document reading section 3, and the image data inputted from external equipment, and converts the image data into the image data that can be printed out The image processing section 72 supplies the writing section 43 with the image data that can be printed out

In the present embodiment, the controller 70 calculates the shift of the sheet from the reference position based on the result of detection by the sensor 62. The controller 70 controls presented correction of the shift in conformity to the calculated shift. To put it more specifically, the controller 70 changes the position wherein latent image writing is started by the writing section 43. This control of changing the latent image writing position allows a latent image to be formed at a desired position of the sheet.

In the present embodiment, however, when an image is to be formed on the envelope, the controller 70 changes the latent image writing position based on the sum total of the result of detecting the shift by the sensor 62 and the length of the flap portion as the length from the end of the flap portion to the end of the main body of the envelope.

[Principle of the Operation of Forming an Image on an Envelope]

Before describing the principle of the operation of forming an image on the envelope in the image forming apparatus 1 of the present embodiment, the following describes the problems that may arise when the envelope is conveyed with the flap portion facing downstream in the sheet conveying direction, as in the image forming method proposed in the Japanese Patent Application Publication No. 2009-58738 and others.

When the envelope is conveyed with the flap portion facing downstream in the sheet conveying direction, there is a problem of the flap portion being deformed when the flap portion of the envelop is made to contact the registration roller, as described above. This problem can be solved by reversing the envelope conveying direction. However, when an image is funned on both sides of the envelope, the conveying direction for forming an image on the observe side of the envelope and that for forming an image on the reverse side are reversed, with the result that the aforementioned problem cannot be solved.

Further, when the envelope is conveyed with the flap portion facing downstream in the sheet conveying direction, there will be a great change in the nip width of the flap portion by the conveying roller in the conveying direction, depending on the shape of the flap portion. This may cause an envelope skew.

To improve the accuracy in the writing position in the main scanning direction perpendicular to the sheet conveying direction, it is normally preferred that the sheet conveyance should be stabilized at the position wherein shift is detected by the sensor 62. Generally, the shift detecting sensor 62 is arranged immediately before on the upstream side of the transferring section 46 in the sheet conveying direction. To improve the accuracy in the writing position on the sheet in the main scanning direction, therefore means should be provided to ensure stability to prevent the sheet from skewing, along the sheet conveyance path leading from the registration roller 61 to the transferring section 46 through the sensor 62.

However, if the envelope is conveyed with the flap portion facing downstream in the sheet conveying direction, the envelope may be skewed when the flap portion passes through the registration roller, as described above. This may reduce the accuracy in the writing position of the envelope in the main scanning direction.

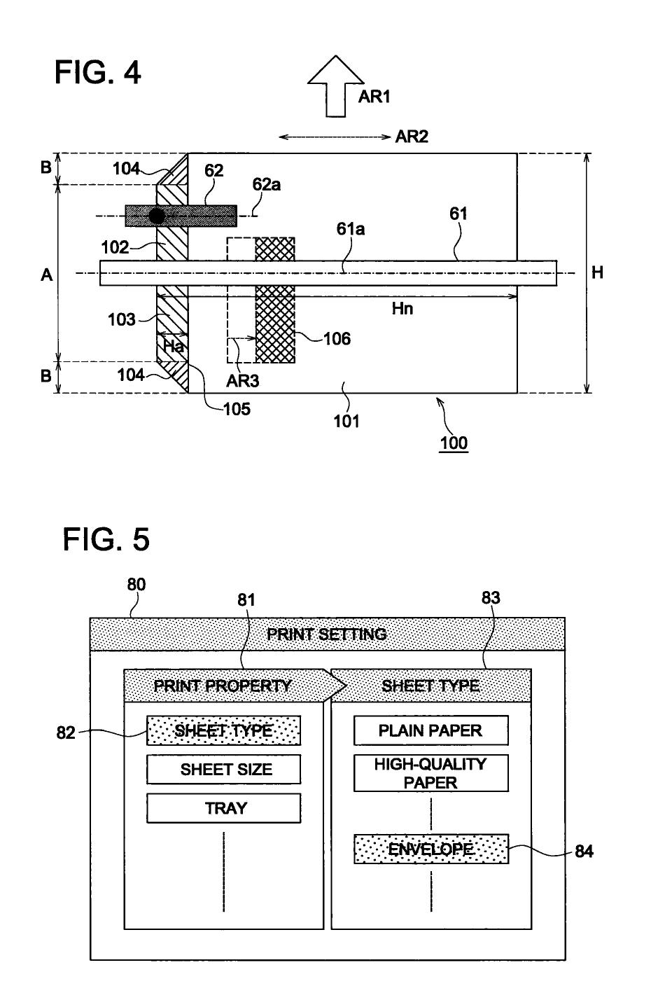

To solve these problems, the image forming apparatus 1 of the present embodiment uses the forming procedure to form an image on the envelope, differently from the method of the normal image formation on plain paper. Referring to FIG. 4, the following specifically describes the principle of the operation of forming an image on the envelope in the present embodiment FIG. 4 is a diagram representing how the envelope 100 is conveyed close to the registration roller 61 in formation of an image on the envelope, as viewed from the side of the image forming section 4 located above.

In the present embodiment, the envelope 100 is conveyed when the side of the main body of the envelope 101 containing the flap portion 102 is kept in parallel with the conveying direction, as shown in FIG. 4. In this case, the main body of the envelope 101 is made to contact the registration roller 61 to correct the skew. To put it another way, when the main body of the envelope 101 has contacted the registration roller 61, the contacting width and the thickness of the contacted portion increase over those of the flap portion 102. Thus, the present embodiment solves the problem of deformation of the flap portion 102 that may occur when skew correction is made by contacting the envelope 100 on the registration roller 61.

In the present embodiment, this is followed by the step of conveying the skew-corrected envelope 100 to the sensor 62 by nipping the same by the registration roller 61. The edge position of the parallel portion 103 of the flap portion 102 is detected by the sensor 62 during the conveyance of the envelope, when the aforementioned registration roller 61 and sensor 62 are located at the aforementioned parallel portion 103 of flap portion 102. To be more specific, in the present embodiment, the shift of the envelope 100 is detected when both the shift detection position 62a of the envelope 100 and the nip position 61a by the registration roller 61 are located within the zone A.

In other cases wherein, for example, at least one of the shift detection position 62a of the envelope 100 and the nip position 61a of the registration roller 61 is located within the inclined portion 104 (zone B of FIG. 4) of the flap portion 102, position detection is not performed.

The following describes why the position of the envelope 100 is detected in the present embodiment only when both the nip position 61a of the registration roller 61 and the sensor 62 are located in the zone A.

In the zone A wherein the parallel portion 103 is located, the nip width Hn of the envelope 100 by the registration roller 61 is constant at the time of conveyance, and therefore, the posture of the envelope 100 during conveyance is stabilized. Thus, when both the nip position 61 a of the registration roller 61 and sensor 62 are located within the zone A, the shift of the envelope 100 is detected. This allows the shift of the envelope 100 to be detected when the posture of the envelope 100 during conveyance is stabilized. This procedure ensures high-precision detection of the shift of the envelope 100 in the main scanning direction AR2 of the envelope 100.

In the meantime, in the zone 13 wherein the inclined portion 104 is located, the nip width Hn of the envelope 100 by the registration roller 61 is changed in the conveying direction AR1 during conveyance. Especially the nip width of the flap portion 102 thinner than the main body of the envelope 101 undergoes a change in the conveying direction AR1. Thus, skew is likely to occur in the zone B because the posture of the envelope 100 during conveyance is not stabilized. In the zone B, further, the edge position of the inclined portion 104 also undergoes a change in the conveying direction AR1. This zone is not preferred in the detection of the edge position. In the present embodiment, when at least one of the shift detection position 62a of the envelope 100 and the nip position 61a of the registration roller 61 is located within the inclined portion 104 (zone B) of the flap portion 102, position detection is not performed.

As described above, in the present embodiment, with consideration given to the shape of the flap portion 102, position detection is performed only in the zone A wherein the posture of the envelope 100 during conveyance is stabilized, and there is no change in the edge position of the envelope 100. Thus, in the present embodiment, the image writing position is changed, based on the result of detecting the shift in such a way that the image writing position in the main scanning direction AR2 will be the reference position.

In this case, however, if the flap portion 102 of the envelope 100 is located on one end wherein the sensor 62 is installed, the latent image writing position is changed with consideration given to the preset width Ha of the flap portion 102 in addition to the result of shift detection. To put it more specifically, the image writing position is changed in such a way that the image 106 will be formed by being shifted by the width Ha of the flap portion 102 in the main scanning direction AR2, in addition to the result of shift detection, as shown by the arrow mark AR3 of FIG. 4. In the meantime, when the flap portion 102 of the envelope 100 is located on the other end different from the end wherein the sensor 62 is installed, and plain paper is employed, the latent image writing position is changed based on the amount of shift alone, without taking account of the width Ha of the flap portion 102.

In the present embodiment, for example, such shape information as the width Ha of the flap portion 102 of the envelope 100, the length of the parallel portion 103 (zone A) of the flap portion 102 and length of the inclined portion 104 (zone B), and the envelope information such as the position of the flap portion 102 in the conveying direction AR1 are preset in the image forming apparatus 1. The aforementioned position detection of the envelope 100 and change of the latent image writing position are performed, based on this information.

Further, in the present embodiment, the time of detecting the shift of the envelope 100 can be set as desired, if it is synchronous as the nip position 61a of the registration roller 61 and sensor 62 are located within the zone A.

For example, the shift detection position 62a of the envelope 100 can be set so that the position intermediate between the nip position 61a of the registration roller 61 and sensor 62 will be located at the center of the envelope 100 in the conveying direction AR1. This provides a surer means for locating both the registration roller 61 and sensor 62 within the zone A.

For example, based on the information on the envelope width H representing the preset length of the preset envelope 100 in the conveying direction AR1, the shift detection position 62a can be set in such a way that both the nip position 61a of the registration roller 61 and sensor 62 am positively located within the zone A. It should be noted that this shift detection position 62a can be set by the controller 70.

The shift detection position 62a for the envelope 100 can be set, for example, by the user directly inputting the position information through an information inputting means such as the operation and display section 71.

For example, the shift detecting position 62a for the envelope 100 can be adjusted based on the driving time of the registration roller 61 when the envelope 100 is conveyed downstream in the conveying direction AR1 after the envelope skew has been corrected by suspending the operation of the registration roller 61.

[Envelope Information Acquisition Procedure]

As described above, in the image forming apparatus 1 of the present embodiment, when an image is formed on the envelope 100, various envelope information of the envelope 100 is set on the image forming apparatus I in advance This envelope information can be set in the following procedures.

(1) Envelope Information Selection Procedure

In the information setting procedure (1), the information on the shape of the envelope 100 such as the regular size used frequently is stored in the image forming apparatus 1 in advance. It should be noted that the envelope 100 whose shape information is stored is not restricted to the envelope 100 of a regular size. The envelope 100 of irregration size can be used When an image is formed, the user operates the operation and display section 71 to display the operation panel for paper selection and selects a desired envelope 100. Thus, the envelope information is set

In this setting procedure (1), it is also possible to arrange such a configuration that the position information on the flap portion 102 of the envelope 100 can be selected by the operation panel. In another procedure for setting the position information of the flap portion 102, it is also possible to arrange such a configuration that the instruction of specifying the direction of setting the flap portion 102 in advance is displayed on the sheet feed cassette 51 and others, so that the user will set the envelope 100 in conformity to this instruction. In this case, a default value is set as the position information on the flap portion 102.

(2) Envelope Information Entering Procedure

In the aforementioned setting procedure (1), desired envelope information is selected from among various forms of envelope information stored in the image forming apparatus 1. Envelopes 100 with a great variety of regular sizes are present on the market. Thus, the setting procedure (1) may not meet all the market requirements.

In the setting procedure (2), to meet the requirements of all forms of envelopes 100, the user sets the shape information of the envelope 100 and the position information of the flap portion 102 for each of the envelopes to be set.

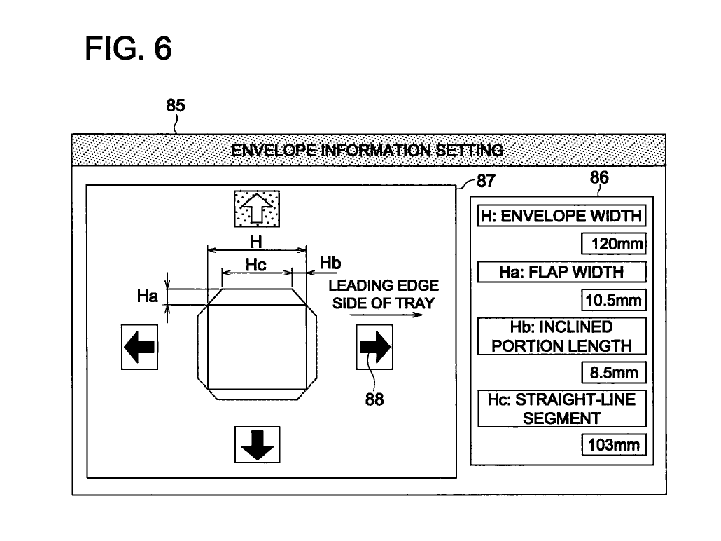

FIGS. 5 and 6 show an example of setting the share information of the envelope 100 and the position information of the flap portion 102 by the setting procedure (2). In the setting procedure (2), the user operates the operation panel of the operation and display section 71 to display the print setting screen 80 as illustrated in FIG. 5. This is followed by the step of the user opening the print property display screen 81 on the print setting screen 80 and selecting the sheet type button 82. This allows the sheet type screen 83 to open.

Then the user selects the envelope mode selection button 84 from the sheet type screen 83. This enables the envelope information setting menu screen 85 of FIG. 6 to be displayed on the operation panel. In the example of FIG. 6, the setting area 86 of the shape information of the envelope 100 and the setting area 87 of the position information of the flap portion 102 are separately displayed on the envelope information setting menu screen 85.

In the setting area 86 of the displayed envelope information setting menu screen 85, the user enters such shape information as envelope width H, flap width Ha, inclined portion length Hb of the flap portion 102 and parallel portion length Hc. The user selects one of the four arrow buttons 88 in the setting area 87 to set the position of the flap portion 102 in the conveying direction AR1 (“tray leading edge” of FIG. 6).

The display from the print menu to the envelope information setting menu can be given in any desired fun n, independently of the example of FIGS. 5 and 6. For example, the setting area 86 and setting area 87 can be displayed as one integral area in the envelope information setting menu screen 85.

Further,, the envelope information setting procedure can be configured independently of the aforementioned setting procedure (1) or (2). For example, the system can be provided with both the setting procedures (1) and (2). In this case, for example, it is possible to arrange such a configuration that the envelope information set in the setting procedure (2) is stored so that this envelope information is used in the subsequent operations of forming an image on the envelope 100.

[Forming an Image on the Envelope]

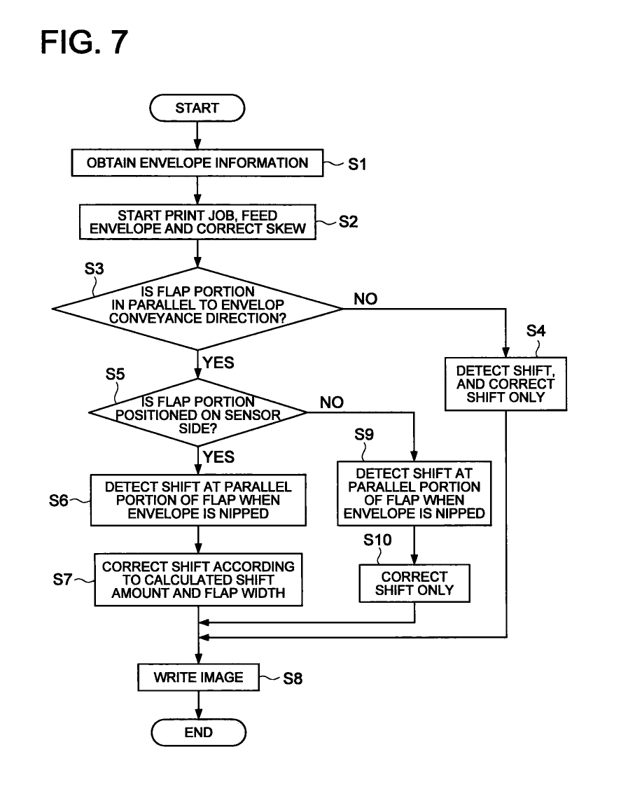

Referring to FIG. 7, the following describes the method for forming an image on the envelope using the image forming apparatus 1 of the present embodiment FIG. 7 is a flowchart representing the procedure of farming an image on an envelope in the present embodiment.

According to the aforementioned setting procedure (1) or (2), the controller 70 of the image forming apparatus 1 acquires the preset envelope information, namely, the shape information of the envelope 100 and the position information of the flap portion 102 (Step S1), for example.

Starting the execution of the job of printing the envelope 100, the controller 70 controls the sheet feed section 5 and feds the envelope 100 to the registration roller 61. The controller 70 then controls the registration roller 61 and loop forming roller 68 to correct the skew of the envelope 100 having been supplied (Step S2). To put it more specifically, after the envelope 100 bas been made to contact the registration roller 61 at a standstill, the envelope 100 is further fed inside from the loop forming roller 68 so as to correct the skew of the envelope 100.

Then the controller 70 determines whether or not the side of the main body of the envelope having a flap portion is parallel to the conveying direction (Step S3).

In Step S3, when the side of the main body of the envelope having the flap portion is not parallel to the conveying direction, or when plain paper is used, the decision in Step S3 is negative (“NO”). In this case, the image forming apparatus 1 only controls correction of shift with respect to the reference position (Step S4).

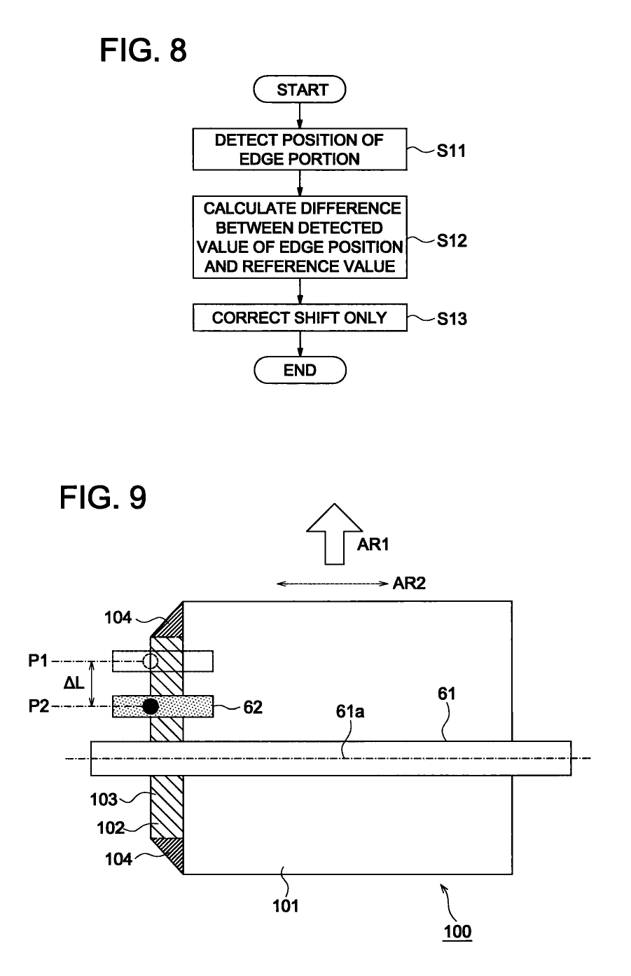

Referring to FIG. 8, the following describes processing in Step S4. FIG. 8 is a flowchart representing the procedures in Step S4.

The controller 70 controls the sensor 62 to detect the shift of the envelope 100 being fed, at a prescribed position so that the edge position of the envelope 100 is detects (Step S11). The shift detection position in this case is predetermined. Then the controller 70 calculates the difference between the edge position detected in Step S11 and the reference position obtained from the size information of the preset envelope 100, and this difference is used as the shift amount (Step S12). Based on the shift amount of the envelope 100 calculated in Step S12, the controller 70 controls only the shift correction (Step S13). To put it more specifically, the controller 70 changes the image writing position so that the latent image writing position in the main scanning direction AR2 by the writing section 43 will be a desired position.

In Step S4, the shift of the envelope 100 is detected and shift correction is controlled, without consideration given to flap width. After that, based on the updated latent image writing position information which has been changed, the writing section 43 writes the image on the envelope 100 (Step S8).

In the meantime, in Step S3, when the side of the main body of the envelope 101 having the flap portion 102 is parallel to the conveying direction, an affirmative decision (YES) is made in Step S3. In this case, the controller 70 determines whether or not the flap portion 102 of the envelope 100 is located on the side of the sensor 62 (Step S5).

In Step S5, when the flap portion 102 of the envelope 100 is located on the side of the sensor 62 (FIG. 4), the decision in Step S5 is affirmative (YES). In this case, the controller 70 conveys the envelope 100 whose skew is corrected by the registration roller 61, to the side of the sensor 62. The controller 70 controls the sensor 62 to detect the shift of the envelope 100 (Step S6) in the middle of conveyance of the envelope 100 when both the sensor 62 and nip position 61a of the registration roller 61 are located in the parallel portion 103 of the zone A. In the process of shift detection in Step S6, the shift amount of the envelope 100 is calculated by the controller 70, similarly to the case of Steps S11 and S12 in FIG. 8.

Based on the calculated shift amount of the envelope 100 and width information of the preset flap portion 102, the controller 70 controls shift correction and changes the latent image writing position in such a way that the latent image writing position in the main scanning direction AR2 will be the reference position (Step S7). The controller 70 then controls the image writing section 43. Based on the updated information of the latent image writing position which has been changed, the writing section 43 writes an image on the envelope 100 (Step S8).

In the meantime, in Step S5, when the flap portion 102 of the envelope 100 is located opposite to the side of the sensor 62, the decision in Step S5 is negative (NO). In this case, the controller 70 conveys the envelope 100 whose skew has been corrected by the registration roller 61, to the sensor 62, similarly to the case of Step S6. The controller 70 controls the sensor 62 to detect the shift of the envelope 100 (Step S9) in the middle of conveyance of the envelope 100 when both the sensor 62 and nip position 61a of the registration roller 61 are located in the parallel portion 103 of the zone A.

Based on the result of detection by the sensor 62, the controller 70 controls only the shift correction in such a way that the latent image writing position by the sensor 62 in the main scanning direction AR2 will reaches the reference position (Step S10). In this case, the flap portion 102 is located opposite to the sensor 62, and the width of the flap portion 102 is not taken into account

The controller 70 controls the writing section 43. Based on the updated latent image writing position information which has been changed, the controller 70 writes an image on the envelope 100 (Step S8). This is how an image is formed on the envelope 100 in the present embodiment

The present embodiment has been described with reference to an example wherein the decision in Steps S3 and S5 is made subsequent to skew correction of the envelope 100 (Step S2), without the present invention restricted thereto. The decision in Steps S3 and S5 can be made at any desired time before shift detection (Step S6 or S9) subsequent to setting of the envelope information (Step S1).

As described above, in the present embodiment, the envelope 100 is conveyed to the registration roller 61 in such a way that the side of the main body of the envelope 101 having a flap portion 102 is parallel to the conveying direction. Further in the present embodiment, the envelope 100 is conveyed while being nipped by the registration roller 61. In the middle of conveyance, the shift of the envelope 100 is detected when both the sensor 62 and nip position 61a of the registration roller 61 are located in the parallel portion 103 (zone A). Thus, in the image forming apparatus 1 of the present embodiment, the skew correction failure of the envelope 100 can be minimized, and an image can be formed accurately at a desired position of the envelope 100 on a stable basis.

In the present embodiment, an image forming apparatus for forming a monochromatic image on a sheet by electrophotographic process has been described as an example of the image forming apparatus 1, without the present invention being restricted thereto. The present invention is also applicable to the image forming apparatus for forming a color image, and similar effects are gained. Further, the present invention is also applicable to the image forming apparatus wherein a desired image forming method other than the electrophotographic method is employed. For example, the present invention is also applicable to the image forming apparatus based on the inkjet method, thermal transfer method and silver halide photographic method. Similar advantages are provided.

### <2. A Wide Variety of Variations>

Without being restricted to the aforementioned embodiment, the present invention can be embodied in a wide variety of variations as shown below.

[Variation 1]

In the aforementioned embodiment, the sensor 62 is used to detect the shift of the envelope 100 to give an example. However, the present invention is rot restricted thereto. For example, shift detection is performed several times at prescribed intervals in the parallel portion 103 (zone A) of the flap portion 102. This procedure enables detection of not only the shift amount of the envelope 100 but also the skew amount (inclination amount) of the envelope 100. To be more specific, the sensor 62 can be used not only to detect the shift of the envelope 100 but also to detect the skew

Referring to FIG. 9, the following specifically describes the principle of shift detection and skew detection in an image furring apparatus as Variation 1. For brevity, FIG. 9 shows an example of detecting a shift at two positions P1 and P2 inside the parallel portion 103 (zone A) of the flap portion 102.

In the example of FIG. 9, shift detection is performed at positions P1 and P2 to acquire not only the amount of shift at each position but also the result of detection including the time of detection. This is followed by the step of finding the distance AL between positions P1 and P2 from the times of shift detection at positions P1 and P2 and the drive speed of the registration roller 61. Then the amount of skew amount is calculated flour the amounts of shift of the envelope 100 detected at the positions P1 and P2 and the calculated distance AL between the positions P1 and P2.

The aforementioned detection of the shift and skew of the envelope 100 is performed when both the sensor 62 and nip position 61a of the registration roller 61 are located in the parallel portion 103 (zone A) of the flap portion 102. This allows the detection of both the shift and skew of the envelope 100 to be performed when the envelope 100 is conveyed on a stable basis. This provides more accurate detection of both the amounts of shift and skew of the envelope 100. Calculation of the skew of the envelope 100 is performed by the controller 70.

As described above, the shift of the envelope 100 is detected at a plurality of positions of the parallel portion 103. Both the amounts of shift and skew of the envelope 100 are calculated. This procedure provides more accurate information on the position of the envelope 100, with the result that more accurate setting of the latent image writing position can be ensured in this example.

[Variation 2]

In the aforementioned embodiment, the envelope information setting procedure has been described with =femme to an example wherein the user sets the envelope information (the aforementioned setting procedure (1) or (2)), without the present invention being restricted thereto. For example, it is also possible to adopt the configuration of Variation 2 wherein an envelope detecting sensor such as an image sensor is installed upstream of the registration roller 61 on the sheet conveyance path S of the envelope 100, so that the envelope information is acquired.

To put it more specifically, for example, it is also possible to arrange such a configuration that an image sensor is installed upstream of the registration roller 61, and the external shape of the envelope 100 is detected by this image sensor Based on the detection result thereof the shape information of the envelope 100 and position information of the flap portion 102 is obtained. It should be noted that a CCD (Charge Coupled Device) image scisor, for example, can be used as the image sensor:

As shown in this example, when an envelope detecting sensor such as an image sensor is installed to get the envelope information, the process of setting the envelope information by the user can be eliminated. This arrangement improves usability of the image forming apparatus.

Instead of the structure wherein the user sets the envelope information through the operation and display section 71 as explained with reference to the aforementioned embodiment, it is possible to adopt the structure wherein the envelope detecting sensor in this example is used to get the envelope information. The structure of this example can be added to the aforementioned embodiment

[Variation 3]

An envelope detecting sensor used to get envelope information can be the sensor having the same structure as that of the sensor 62 for detecting the edge position of the sheet (Variation 3). In this case, the envelope detecting sensor is installed upstream of the registration roller 61 in the conveying direction AR1. This envelope detecting sensor is employed to measure the edge position of the flap portion 102 of the envelope 100 continuously or at prescribed intervals. The shape information of the envelope 100 and the position information of the flap portion 102 are obtained based on the result of measurement by the envelope detecting sensor.

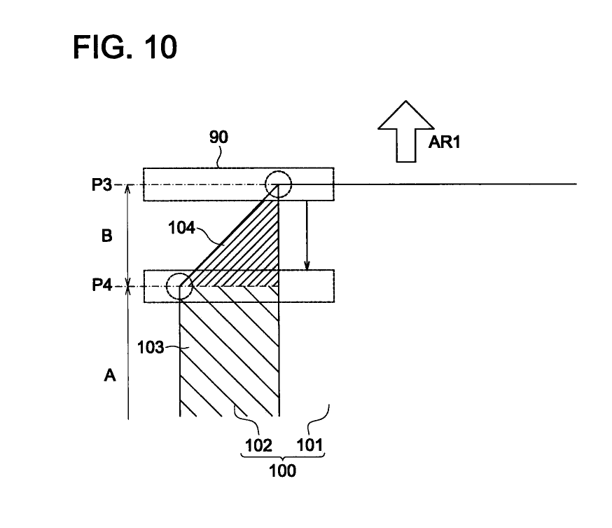

FIG. 10 schematically shows the principle of detecting the envelope information in this example. In the example of FIG. 10, the sensor 90 having the same structure as that installed downstream of the registration roller 61 is employed as an envelope detecting sensor 62.

In this example, when the detection of the shift of the envelope 100 has started by the sensor 90 upstream of the registration roller 61, detection is made of the edge position close to the boundary between the inclined portion 104 of the flap portion 102 and the main body of the envelope 101 at the position P3 in the conveying direction AR1 of FIG. 10.

If shift is detected by the sensor 90 continuously or at prescribed intervals while the envelope 100 is conveyed, there is a continuous change in the edge position to be detected until the sensor 90 reaches the position P4 on the boundary between the inclined portion 104 of the flap portion 102 and the parallel portion 103. This is followed by continuous change in the edge position to be detected. If shift is still detected by the sensor 90 further continuously while the envelope 100 is conveyed, the zone wherein shift is detected corresponds to the parallel portion 103. Thus, there will be almost no change in the edge position to be detected.

To be more specific, while shift detection is performed on the inclined portion 104 (zone B) of the flap portion 102, there is a great change in the result of detecting the edge position. While shift detection is performed on the parallel portion 103 (zone A), there is a reduced change in the result of detections. Thus, the boundary between the inclined portion 104 of the flap portion 102 and parallel portion 103 can be identified by detecting the amount of change in the result of detection by the sensor 90. The shape information of the envelope 100 can be obtained automatically based on the result of this identification.

Further, when the flap portion 102 is not located on the side of the sensor 90, there is almost no change in the result of detecting the edge position. To be more specific, according to the method of this example, it is possible to determine whether or not the flap portion 102 is located on the side of ₜhe sensor 90, based on the result of detection obtained from the sensor 90. The position information of the flap portion 102 can also be obtained. It should be noted that the aforementioned shape information and position information of the envelope 100 can be calculated and acquired, for example, by the controller 70.

In the example of FIG. 10, an envelope detecting sensor for acquiring the envelope information is installed separately, without the present invention being restricted thereto. For example, when the controller 70 has a sufficiently high throughput, the sensor 62 installed downstream in the conveying direction AR1 of the registration roller 61 can be employed to get envelope information. In this case, there is no need of increasing the number of the sensors, and apparatus configuration can be more simplified.

Further, when envelope information is to be obtained using the sensor 62 installed downstream in the conveying direction AR1 of the registration roller 61, the following structure can be iced, for example. The envelope 100 is conveyed to the side of the sensor 62 by the registration roller 61, and the external shape of the envelope 100 is detected by the sensor 62. Then the envelope 100 is returned upstream of the registration roller 61 in the conveying direction AR1. After that, shift detection of the envelope 100 is performed, similarly to the case of the aforementioned embodiment In this case, the controller 70 is not required to have a sufficiently high throughput

As described above, in this example as well, the process of setting the envelope information by the user can be eliminated, similarly to the case of the aforementioned Variation 2. This arrangement enhances usability of the image forming apparatus.

The structure of the envelope information to be set by the user through the operation and display section 71 explained with reference to the aforementioned embodiment can be replaced by the structure of this example wherein the envelope detecting sensor is used to get envelope information. It is also possible to add the structure of this example to the aforementioned embodiment

As described above, in the embodiment of the present invention, when an image is formed on the envelope the envelope is conveyed to the registration roller in such a way that the side of the main body of the envelope having a flap portion is kept parallel to the conveying direction. To be more specific, a thicker main body of envelope is made to contact the registration roller to correct the skew of the envelope. Thus, according to the embodiment of the present invention, it is possible to minimize the possible failure in skew correction of the envelope.

Further, in the embodiment of the present invention, when an envelope having a flap portion is nipped by the registration roller and is conveyed to the transferring section, the edge position of the parallel portion of the flap portion is detected by the sensor, when the registration roller and sensor are located at the parallel portion of the flap portion. To be more specific, the edge of the envelope is detected when both the sensor and registration roller are located at the place the envelope is conveyed in the stable area wherein the nip width of the envelope nipped by the registration roller is constant. Thus, in the embodiment of the present invention, the envelope position can be detected when the envelope conveying state is stable. This arrangement ensures more accurate detection of the amount of shift in the envelope conveying direction. More accurate setting of the image writing position enables an image to be formed at a desired position of the envelope on a stable basis.

What is claimed is:

1. An image forming apparatus comprising
(a) a photoreceptor;
(b) a writing section which writes a latent image on the photoreceptor,
(c) a developing section which forms a toner image by developing the latent image;
(d) a transferring section which transfers the toner image on an envelope having a flap portion composed of a parallel portion and an inclined portion, and a main body of the envelope;
(e) a registration roller which corrects a skew of the envelope and conveys the envelope to the transferring section;
(f) a sensor provided between the transferring section and the registration roller, which detects a position of an end of the parallel portion of the flap portion that is in parallel with a conveyance direction of the envelope; and
(g) a controller which controls the writing section, the registration roller and the sensor, wherein in a case when the envelope is conveyed with a side of the main body of the envelope having the flap portion being parallel to the conveying direction and the flap portion being located where the end is detected by the sensor, the controller allows the sensor to detect a position of the end of the parallel portion of the flap portion when the registration roller and the sensor are located at the parallel portion of the flap portion, and the controller changes a latent image writing position by the writing section in an image scanning direction perpendicular to the conveyance direction of the envelope according to the detection result by the sensor.

2. The image forming apparatus of claim 1, wherein the change of the writing position is a change of a position as a sum total of a shift amount with respect to a reference position and a length from the end of the flap portion to an end of the main body of the envelope.

3. The image forming apparatus of claim 1, wherein when the envelope is conveyed with the side of the main body of the envelope having the flap portion being parallel to the conveying direction, and the flap portion being not located where the end is not detected by the sensor; and the change of the writing position is only a change of a shift amount with respect to the reference position.

4. The image forming apparatus of claim 1, wherein position information of the flap portion of the envelope is set beforehand.

5. The image forming apparatus of claim 4, further comprising an operation and display section which sets the position information of the flap portion.

6. The image forming apparatus of claim 1, wherein the sensor detects the flap portion at a plurality of positions thereof in the conveyance direction of the envelope, and the controller calculates a skew amount of the envelope based on the detected result.

7. The image forming apparatus of claim 6, wherein the controller calculates the skew amount of the envelope based on the detected result of the plurality of positions and a drive period of time of the registration miler when the detection of the plurality of positions is conducted.

8. The image forming apparatus of claim 1, further comprising an envelope detecting sensor which detects shape information of the envelope and the position of the flap portion in the conveying direction.

9. The image forming apparatus of claim 8, wherein the envelope detecting sensor detects the position of the end of the flap along the envelope conveying direction continuously or at prescribed intervals.

10. The image forming apparatus of claim 1, wherein a layout position of the sensor is set beforehand.

11. An image forming method of an image forming apparatus having: a photoreceptor; a writing section which writes a latent image on the photoreceptor, a developing section which forms a toner image by developing the latent image; a transferring section which transfers the toner image on an envelope having a flap portion composed of a parallel portion and an inclined portion, and a main body of the envelope; a registration roller which corrects a skew of the envelope and conveys the envelope to the transferring section; a sensor provided between the transferring section and the registration roller, which detects a position of an end of the parallel portion of the flap portion that is in parallel with a conveyance direction of the envelope; and a controller which controls the writing section, the registration miler and the sensor,
wherein the method comprising the steps of:
conveying the envelope to the registration roller in a state that a side of the main body of the envelope having the flap portion is parallel to the conveying direction and the flap portion is located where the end is detected by the sensor;
correcting a skew of the envelope by the registration roller;
allowing the sensor to detect a position of the end of the parallel portion of the flap portion when the registration roller and the sensor are located at the parallel portion of the flap portion; and
changing a latent image writing position by the writing section in an image scanning direction perpendicular to the conveyance direction of the envelope according to the detection result by the sensor.

12. The image funning method of claim 11, wherein the change of the writing position is a change of a position as a sum total of a shift amount with respect to a reference position and a length from the end of the flap portion to an end of the main body of the envelope.

13. The image forming method of claim 11, further comprising the step of conveying the envelope to the registration roller with the side of the main body of the envelope having the flap portion being parallel to the conveying direction, and the flap portion being located where the end is not detected by the sensor, and the change of the writing position is only a change of a shift amount with respect to the reference position.
